(19) United States
(12) Patent Application Publication
(10) Pub. No.: US 2013/0038535 A1
(43) Pub. Date: Feb. 14, 2013

(54) OPTICAL POINTING DEVICE

(71) Applicants: Hui-Hsuan Chen, Hsinchu (TW); Tien-Chia Liu, Hsinchu (TW)

(72) Inventors: Hui-Hsuan Chen, Hsinchu (TW); Tien-Chia Liu, Hsinchu (TW)

(73) Assignee: PixArt Imaging Inc., Hsinchu (TW)

(21) Appl. No.: 13/277,494

(22) Filed: Oct. 20, 2011

(30) Foreign Application Priority Data
Aug. 12, 2011 (TW) 100128985

(51) Int. Cl. G06F 3/033

(52) U.S. Cl. 345/166

(57) ABSTRACT

An optical pointing device for detecting a displacement between the optical pointing device and a working surface includes a casing, a light emitting component and a light sensing component. The casing includes a transparent element. A light emitting hole is defined through the casing and located at the same side with the transparent element. The light emitting component is located inside the casing and emits a light beam. The light beam passes through the light emitting hole and is reflected by the working surface to pass through the transparent element. The light sensing component is located inside the casing. The transparent element is located between the light sensing component and the working surface to cover the light sensing component. The light sensing component has a light sensing surface configured for sensing the light beam reflected by the working surface.

### TECHNICAL FIELD

The disclosure relates to a pointing device, and more particularly to an optical pointing device.

### BACKGROUND

With development of electronic technology, human-computer interfaces are widely used in electronic devices to facilitate operations for the electronic devices. In many kinds of human-computer interfaces, mice are more widely used than other human-computer interfaces, and are suitable for the operation habits of most users. Furthermore, compared with rolling mice, optical mice have many advantages, such as highly wear-resistant, not requiring frequent cleaning, and having a precision that does not decrease with an increase of using time. Therefore, optical mice have already replaced rolling mice to occupy a main part of the market of mice.

FIG. 1 is a schematic view of a typical optical mouse 100. Referring to FIG. 1, the optical mouse 100 includes a casing 110, a light emitting component 120, and a light sensing component 130. The light emitting component 120 and the light sensing component 130 are received in the casing 110. A transparent plate 112 is mounted on a bottom of the casing 111, and the light emitting component 120 provides a light beam 122 towards the transparent plate 112. When the optical mouse 100 is placed on a working surface 50, the light beam 122 provided by the light emitting component 120 passes through the transparent plate 112, and then is reflected by the working surface 50 to become a reflected light beam 122′. The light beam 122′ reflected by the working surface 50 passes through the transparent plate 112 and arrives at the light sensing component 130. The light sensing component 130 can determine directions and distances of movements of the optical mouse 100 on the working surface 50 according to the light beam 122′ sensed by the light sensing component 130.

The aforementioned working surface 50 is a surface that is used to reflect the light beam 122. Thus, a predetermined distance should be kept between the light sensing component 130 and the working surface 50 to ensure that the light beam 122′ can be exactly transmitted to a light sensing surface of the light sensing component 130. In other words, if an unwanted object on the working surface 50 extends into the casing 100, the light beam 122 may be reflected to the light sensing component 130 by the unwanted object, and thus a sensing precision of the light sensing component 130 may decrease.

In the typical optical mouse 100, the transparent plate 112 can prevent unwanted objects on the working surface 50 from extending into the casing 110 through a bottom of the casing 110. However, the transparent plate 112 may directly reflect a portion of the light beam 122 before the light beam 122 passes through the transparent plate 112, such that a light beam 123 is resulted and transmitted to the light sensing component 130, as shown in FIG. 1 by dashed lines. Thus, a sensing effect of the light sensing component 130 may be adversely affected.

FIG. 2 is a schematic view of another typical optical mouse 200. Referring to FIG. 2, the optical mouse 200 is substantially similar to the optical mouse 100, and differs from the optical mouse 100 only in that the optical mouse 200 further includes a light shielding plate 211. The light shielding plate 211 is received in the casing 110 and vertically mounted between the light emitting component 120 and the light sensing component 130 to shield the light beam 123 reflected by the transparent plate 112, and thus prevents the light beam 123 from adversely affecting the sensing effect of the light sensing component 130.

### SUMMARY OF EMBODIMENTS

Accordingly, the disclosure provides an optical pointing device for detecting a displacement between the optical pointing device and a working surface. The optical pointing device includes a casing, a light emitting component and a light sensing component. The casing includes a transparent element. A light emitting hole is defined through the casing and located at the same side with the transparent element. The light emitting component is located inside the casing and emits a light beam. The light beam passes through the light emitting hole and is reflected by the working surface to pass through the transparent element. The light sensing component is located inside the casing. The transparent element is located between the light sensing component and the working surface to cover the light sensing component. The light sensing component has a light sensing surface configured for sensing the light beam reflected by the working surface. The casing maintains a settled distance between the light sensing component and the working surface.

### BRIEF DESCRIPTION OF THE DRAWINGS

The above embodiments of the disclosure will become more readily apparent to those ordinarily skilled in the art after reviewing the following detailed description and accompanying drawings.

FIG. 1 is a schematic, cutaway view of a typical optical mouse according to the related art.

FIG. 2 is a schematic, cutaway view of another typical optical mouse according to the related art.

FIG. 3A is a schematic, cutaway view of an optical pointing device according to a first exemplary embodiment.

FIG. 3B is a bottom plan view of the optical pointing device of FIG. 3A.

FIG. 4 is a schematic, cutaway view of an optical pointing device according to a second exemplary embodiment.

FIG. 5 is a bottom plan view of the optical pointing device of FIG. 4.

FIG. 6A is a schematic, cutaway view of an optical pointing device according to a third exemplary embodiment.

FIG. 6B is a bottom plan view of the optical pointing device of FIG. 6A.

FIG. 7A is a schematic, cutaway view of an optical pointing device according to a fourth exemplary embodiment.

FIG. 7B is a top plan view of the optical pointing device of FIG. 7A.

FIG. 8A is a schematic, cutaway view of an optical pointing device according to a fifth exemplary embodiment.

FIG. 8B is a top plan view of the optical pointing device of FIG. 8A.

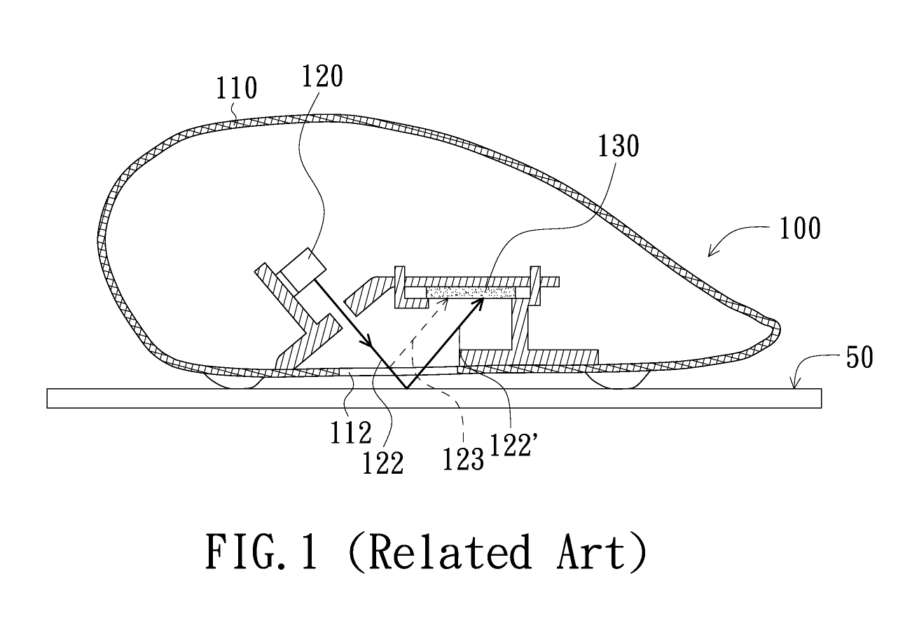

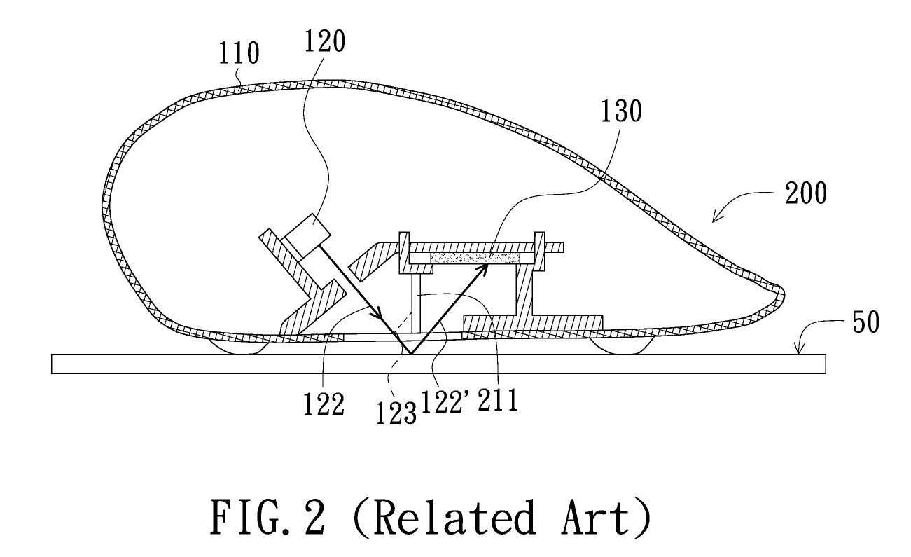

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

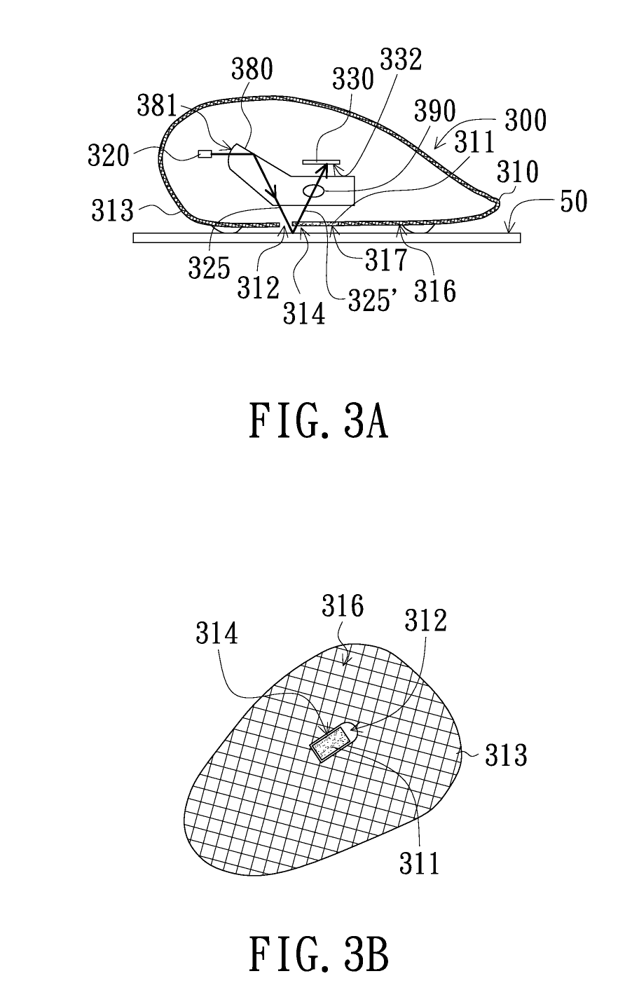

FIG. 3 is a schematic, cutaway view of an optical pointing device according to a first exemplary embodiment. FIG. 3B is a bottom plan view of the optical pointing device of FIG. 3A. For clarifying and simplifying the drawings, some conventional components are omitted in the drawings. Sizes of components shown in the drawings and ratios of the sizes of the components shown in the drawings to each other are for reference only, and may not be real sizes and ratios. Referring to FIG. 3A and FIG. 3B, an optical pointing device 300 according to the first exemplary embodiment is adapted to detect a relative displacement between the optical pointing device 300 and a working surface 50, and generate a displacement signal to move a cursor displayed by an electronic device (not shown) electrically connected to the optical pointing device 300. The optical pointing device 300 includes a casing 310, a light emitting component 320, and a light sensing component 330. The casing 310 includes a transparent element 311 and a light emitting hole 312 located at the same side thereof. The light emitting component 310 and the light emitting component 320 are located inside the casing 310. A light beam 325 emitted from the light emitting component 320 can pass through the light emitting hole 312 to an outside of the casing 310 and then be reflected by the working surface 50 to become a reflected light beam 325′, and the light beam 325′ can pass through the transparent element 311 to an inside of the casing 310 to be sensed by the light sensing component 330. The transparent element 311 of the casing 310 is located between the light sensing component 330 and the working surface 50 to cover the light sensing component 330. A light sensing surface 332 of the light sensing component 330 is substantially positioned to confront the transparent element 311 of the casing 310.

In particular, the light emitting component 320 can be a light emitting diode (LED), a laser diode, or other suitable light emitting components. The light sensing component 330 can be a complementary metal-oxide-semiconductor (CMOS), a charge-coupled device (CCD), or other suitable light sensing components. Furthermore, the transparent element 311 can be made of a light filtering material. Materials of the transparent element 311 can be determined according to a spectrum of the light beam 325 provided by the light emitting component 320, such that only the light emitted from the light emitting component 320 can pass through the transparent element 311 and the ambient light around the optical pointing device 300 can be filtered by the transparent element 311 and prevented from interfering with a sensing effect of the light sensing component 330. For example, if the light emitting component 320 is an infrared LED, the transparent element 311 can be made of a light filtering material that only allows infrared light to pass through.

Additionally, the optical pointing device 300 can further include a light guiding member 380 and a light converging member 390. The light guiding member 380 can be a light pipe located inside the casing 310 and mounted between the light emitting component 320 and the light emitting hole 312. The light converging member 390 can be a convex lens or other lenses that are capable of converging light. The light converging member 390 is located inside the casing 310 and mounted between the transparent element 311 and the light sensing component 330. The light guiding member 380 is used to guide the light beam 325 to the light emitting hole 312, and the light converging member 390 is used to converge the light beam 325′ on the light sensing surface 332 of the light sensing component 330. Furthermore, a surface 381 of the light guiding member 380 that faces directly towards the light emitting component 320 can be a light converging surface for converging light from the light emitting component 320 and accordingly improving efficiency of use of the light. Additionally, in this embodiment, the light guiding member 380 and the light converging member 390 can be integrally formed to be a monolithic structure. In other embodiments, the light guiding member 380 and the light converging member 390 can also be separately formed and then connected to each other. It should be noted that the light beams (e.g., 325, 325′) shown in the drawings are only used to indicate approximate transmitting paths of light, and may not be real light paths of the light beams. In other embodiments, the light sensing surface 332 can be placed to form an inclined angle relative to the working surface 50, according to design and disposition of the light converging component 390.

In this embodiment, the optical pointing device 300 is illustrated in the example of an optical mouse, and the working surface 50 is a surface on which the optical mouse is placed. In particular, the casing 310 of the optical pointing device 300 further includes a bottom plate 313. The bottom plate 313, the transparent element 311, and the light emitting hole 312 are located at the same side (i.e., the bottom side) of the casing 311. A portion of the bottom plate 313 defines an opening 314. The transparent element 311 is received in the opening 314 to partially cover the opening 314. The transparent element 311 can be made of glass, acrylic, or other transparent material. The light emitting hole 312 is formed by a portion of the opening 314 that is not covered by the transparent element 311. Furthermore, an outer surface 316 of the bottom plate 313 and an outer surface 317 of the transparent element 311 are coplanar and located at the same plane. When the optical pointing device 300 is placed on the working surface 50 for operating an electronic device, the working surface 50 covers the light emitting hole 312. The light beam 325 emitted from the light emitting component 320 passes through the light emitting hole 312, and then is reflected by the working surface 50 to become the light beam 325′. The light beam 325′ passes through the transparent element 311 to enter into the casing 310 and then is received by the light sensing surface 332 of the light sensing component 330. Because the light beam 325 provided by the light emitting component 320 transmits out of the casing 310 through the light emitting hole 312, the situation that a portion of the light beam 325 is directly reflected to the light sensing component 330 by the transparent element 311 does not occur. Thus, a sensing effect of the light sensing component 330 is prevented from being adversely affected. Furthermore, the transparent element 311 of the casing 310 covers the light sensing component 330, and thus unwanted objects can be prevented from entering the casing 310 and reflecting the light beam 325 to the light sensing surface 332 of the light sensing component 330. Because the light sensing component 330 is covered by the transparent element 311, a settled distance between the light sensing component 330 and the working surface 50 can be maintained. All of the aforementioned advantages can further prevent the sensing effect of the light emitting component 330 from being adversely affected. Therefore, the optical pointing device 300 can be used in working conditions with non-smooth surfaces, such as on blankets, and thus is more practically useful than conventional typical optical pointing devices.

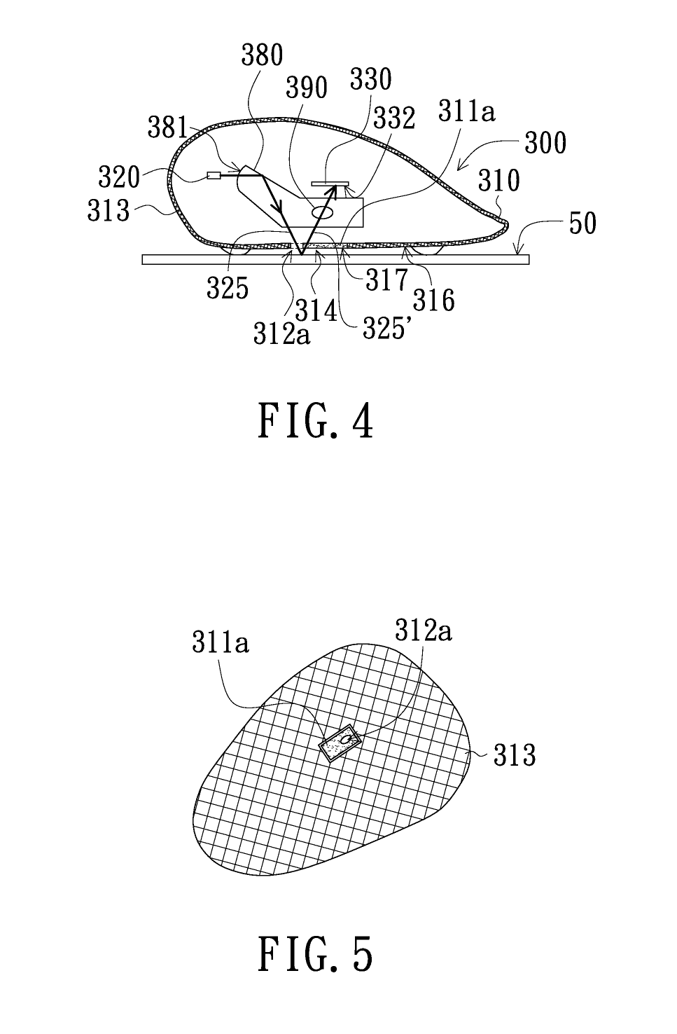

FIG. 4 is a schematic, cutaway view of an optical pointing device, according to a second exemplary embodiment. FIG. 5 is a bottom plan view the optical pointing device shown in FIG. 4. Referring to FIG. 4 and FIG. 5, an optical pointing device 300a according to the second exemplary embodiment is substantially similar to the optical pointing device 300, and differs from the optical pointing device 300 only in that the optical pointing device 300a includes a transparent element 311a and a light emitting hole 312a that are different from the transparent element 311 and the light emitting hole 312 of the optical pointing device 300. In this embodiment, a shape and a size of the transparent element 311a are substantially the same as the shape and the size of the opening 314. The transparent element 311a is fittingly received in the opening 314 and fully covers the opening 314, and the light emitting hole 312a for allowing the light beam 325 to pass through is formed in the transparent element 311a. That is, the transparent element 311a defines the light emitting hole 312a. Advantages of the optical pointing device 300a are similar to that of the optical pointing device 300, and thus it is unnecessary to go into details here.

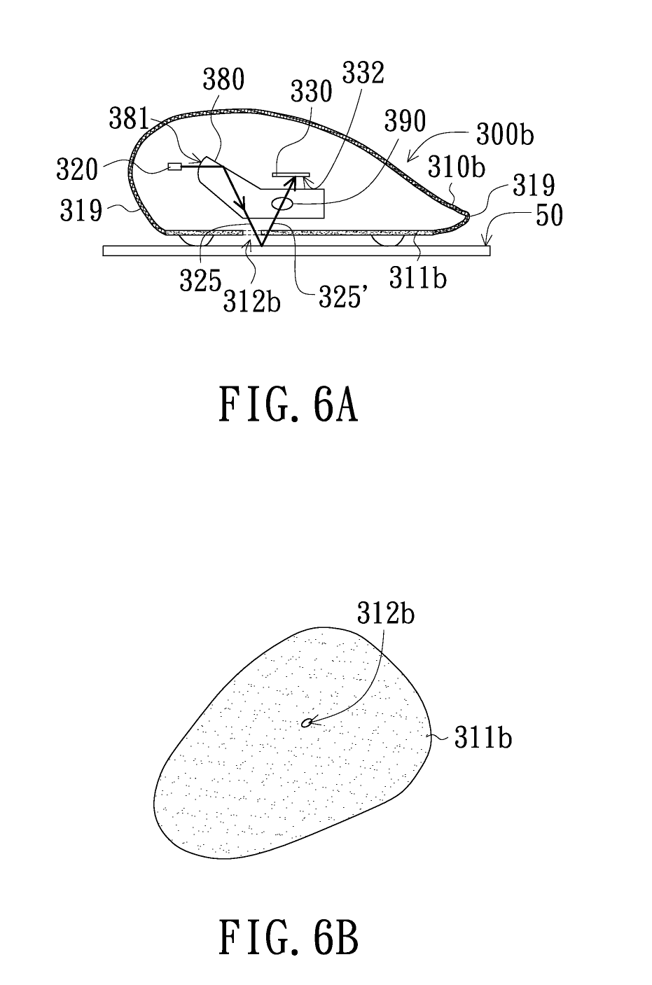

Although the bottom plates and transparent elements of the aforementioned exemplary embodiments are independent from each other, in other embodiments, the bottom plates and the transparent elements can also be integrated together. FIG. 6A is a schematic, cutaway view of an optical pointing device, according to a third exemplary embodiment. FIG. 6B is a bottom plan view of the optical pointing device shown in FIG. 6A. Referring to FIG. 6A and FIG. 6B, an optical pointing device 300b according to the third exemplary embodiment is substantially similar to the optical pointing device 300, and differs from the optical pointing device 300 only in that the optical pointing device 300b includes a casing 310b that is different from the casing 310 of the optical pointing device 300. The casing 310b includes a transparent element 311b with a relatively large size, and the transparent element 311b is also used as a bottom plate of the casing 310b. The transparent element 311b is connected to a plurality of sidewalls 319 of the casing 310b, and a light emitting hole 312b (i.e., similar to the light emitting hole 312a) is formed in the transparent element 311b. That is, the bottom plate and the transparent element 311b of the optical pointing device 300b are integrated into one component and are made of transparent material, such as acrylic.

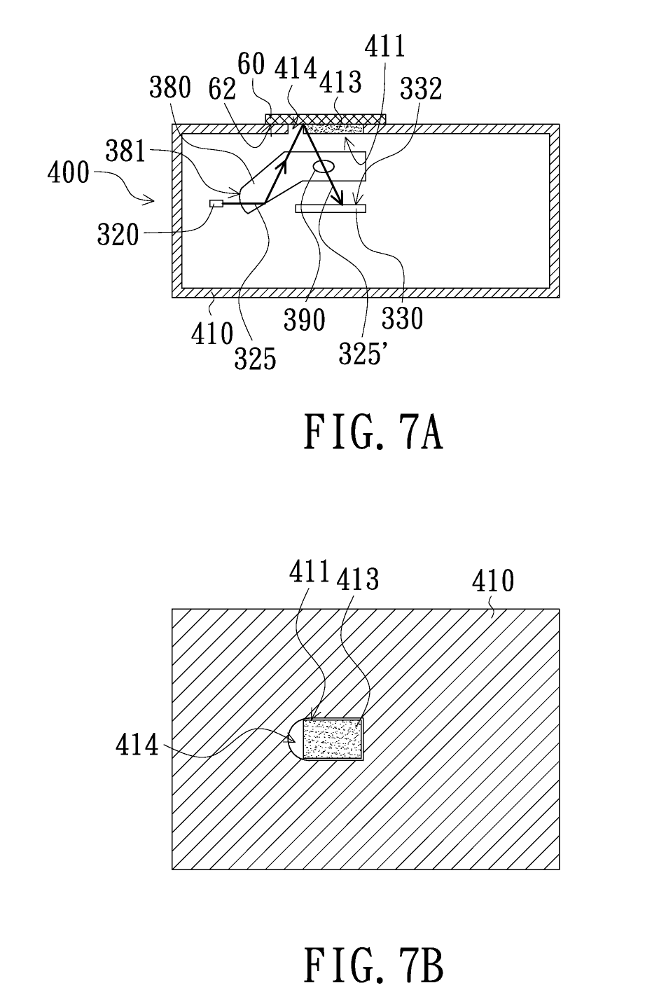

It should be noted that, although all of the optical pointing devices 300, 300a, and 300b according to the aforementioned exemplary embodiments are illustrated in the examples of optical mice, applications of the optical pointing devices of the present disclosure are not limited by the aforementioned exemplary embodiments. FIG. 7A is a schematic, cutaway view of an optical pointing device, according to a fourth exemplary embodiment. FIG. 7B is a top plan view of the optical pointing device shown in FIG. 7A. Referring to FIG. 7A and FIG. 7B, the optical pointing device 400 according to the fourth exemplary embodiment includes a casing 410. The casing 410 includes an opening 411 formed in a side thereof, a transparent element 413 is partially received in the opening 411, and a portion of the opening 411 that is not covered by the transparent element 413 is used as a light emitting hole 414. The side of the casing 410 that forms the opening 411 and receives the transparent element 413 can be used to contact an object 60. Similarly, the optical pointing device 400 can further include a light emitting component 320, a light sensing component 330, a light guiding member 380, and a light converging member 390. A surface 381 of the light guiding member 380 that faces directly towards the light emitting component 320 can be formed as a light converging surface.

When the object 60 is located adjacent to the light emitting hole 414, a surface 62 of the object 60 that is located towards the light emitting hole 414 is used as a working surface. A light beam 325 provided by the light emitting component 320 is guided to the surface 62 by the light guiding member 380, then reflected by the surface 62 to pass through the transparent element 413 to enter into the casing 410, and finally transmitted to and projected on the light sensing surface 332 of the light sensing component 330 through the light converging member 390. When the object 60 moves, a position of projection of the light beam 325 on the light sensing surface 332 changes correspondingly, and thus directions and distances of movements of the object 60 relative to the optical pointing device 400 can be determined accordingly.

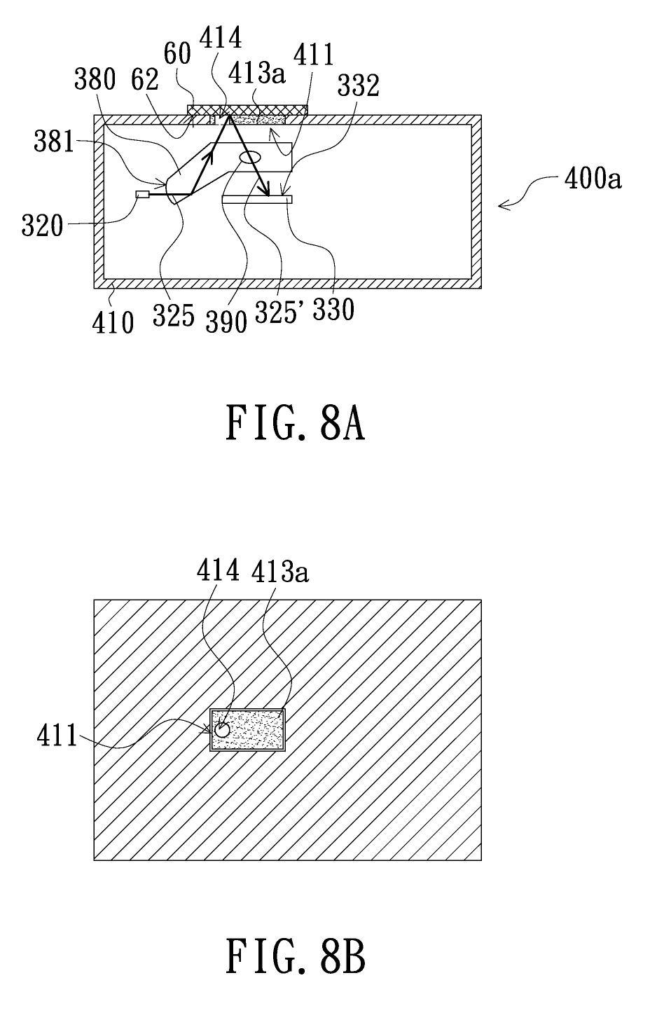

FIG. 8A is a schematic, cutaway view of an optical pointing device, according to a fifth exemplary embodiment. FIG. 8B is a top plan view of the optical pointing device shown in FIG. 8A. Referring to FIG. 8A and FIG. 8B, the optical pointing device 400a according to the fifth exemplary embodiment is substantially similar to the optical pointing device 400, and differs from the optical pointing device 400 only in that the optical pointing device 400a includes a transparent element 413a fittingly received in the opening 411 and fully covers the opening 411, and the light emitting hole 414 is formed in the transparent element 413a. That is, the light emitting hole 414 is a hole defined within the transparent element 413a.

Additionally, in all of the aforementioned exemplary embodiments, the light guiding members 380 and the light converging members 390 can be integrally formed together, or separately formed and then assembled together and mounted in the casings (e.g., 310, 310b, 410). Differences between these methods do not affect light guiding effects of the light guiding members 380 and light converging effects of the light converging members 390.

In conclusion, in the optical pointing devices (e.g., 300, 300a, 300b, 400, 400a) of the present disclosure, the light beams (e.g., 325) emitted from the light emitting components (e.g., 320) are transmitted out of the casings (e.g., 310, 310b, 410) through the light emitting holes (e.g., 312, 312a, 312b, 414). Therefore, the light beams can be prevented from being directly reflected to the light sensing components (e.g., 330) by the transparent elements (e.g., 311, 311a, 311b, 413, 413a), and sensing precisions of the light sensing components can be ensured. Furthermore, because the transparent elements of the casings cover the light sensing components, unwanted objects can be prevented from entering the casings and adversely affecting sensing effects of the light sensing components. Therefore, the optical pointing devices of the present disclosure can be used in working conditions with non-smooth surfaces, such as on blankets, and thus are more practically useful than conventional typical optical pointing devices.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An optical pointing device for detecting a displacement between the optical pointing device and a working surface, the optical pointing device comprising:
a casing including a transparent element, a light emitting hole defined through the casing and located at the same side with the transparent element;
a light emitting component located inside the casing and emitting a light beam, the light beam passing through the light emitting hole and reflected by the working surface to pass through the transparent element; and
a light sensing component located inside the casing, the transparent element located between the light sensing component and the working surface to cover the light sensing component, the light sensing component having a light sensing surface configured for sensing the light beam reflected by the working surface, the casing maintaining a settled distance between the light sensing component and the working surface.

2. The optical pointing device according to claim 1, wherein the optical pointing device is an optical mouse, the working surface being a surface on which the optical mouse is placed.

3. The optical pointing device according to claim 1, wherein the casing includes a bottom plate located at the same side with the transparent element and the light emitting hole, a portion of the bottom plate defining an opening, the transparent element received in the opening to partially cover the opening, and a portion of the opening that is not covered by the transparent element forming the light emitting hole.

4. The optical pointing device according to claim 3, wherein the optical pointing device is an optical mouse, and an outer surface of the bottom plate and an outer surface of the transparent element are coplanar and located at the same plane.

5. The optical pointing device according to claim 1, wherein the casing includes a bottom plate located at the same side with the transparent element and the light emitting hole, a portion of the bottom plate defining an opening, the transparent element received in the opening and fully covering the opening, the light emitting hole defined in the transparent element.

6. The optical pointing device according to claim 5, wherein the optical pointing device is an optical mouse, and an outer surface of the bottom plate and an outer surface of the transparent element are coplanar and located at the same plane.

7. The optical pointing device according to claim 1, wherein the transparent element functions as a bottom plate of the casing and is connected to sidewalls of the casing, and the light emitting hole is defined in the transparent element.

8. The optical pointing device according to claim 1, further comprising:
a light guiding member located inside the casing and between the light emitting component and the light emitting hole, the light guiding member configured for guiding the light beam of the light emitting component to the light emitting hole; and
a light converging member located inside the casing and between the transparent element and the light sensing component, the light converging member configured for converging the light beam reflected by the surface on the light sensing surface.

9. The optical pointing device according to claim 8, wherein the light guiding member and the light converging member are integrally formed.

10. The optical pointing device according to claim 8, wherein the light guiding member and the light converging member are separately formed and connected to each other.

11. The optical pointing device according to claim 8, wherein a surface of the light guiding member that faces towards the light emitting component is a light converging surface for converging the light beam of the light emitting component.
